(19) United States
(12) Patent Application Publication
(10) Pub. No.: US 2020/0185822 A1
(43) Pub. Date: Jun. 11, 2020

(54) ANTENNA DEVICE

(71) Applicant: DENSO CORPORATION, Kariya-city (JP)

(72) Inventors: Toshiya SAKAI, Nisshin-city (JP); Kazumasa SAKURAI, Nisshin-city (JP); Asahi KONDO, Kariya-city (JP)

(21) Appl. No.: 16/794,702

(22) Filed: Feb. 19, 2020

Related U.S. Application Data
(63) Continuation of application No. PCT/JP2018/030558, filed on Aug. 17, 2018.

(30) Foreign Application Priority Data
Aug. 21, 2017 (JP) 2017-158690

(51) Int. Cl. H01Q 1/38; H01Q 1/52; H01Q 1/48

(52) U.S. Cl. CPC H01Q 1/38; H01Q 1/48; H01Q 1/521

(57) ABSTRACT

An antenna device includes a dielectric substrate having a first surface on which an antenna part is formed and a second surface on which a base plate is formed. The antenna part has one or more antenna patterns configured to act as radiating elements. The antenna patterns resonate in one or more resonance directions to incident waves having an operating frequency of the antenna part, thereby generating emitted waves having polarized waves different from those of transmitted/received waves which are transmitted/received by the antenna part. For each of the resonance directions, the antenna patterns include at least one line pattern having a width which is narrower than the total width of the antenna patterns in a direction perpendicular to the resonance direction.

### CROSS-REFERENCE TO RELATED APPLICATION

The present application is a continuation application of International Application No. PCT/JP2018/030558, filed Aug. 17, 2018, which claims priority to Japanese Patent Application No. 2017-158690, filed Aug. 21, 2017. The contents of these applications are incorporated herein by reference in their entirety.

### BACKGROUND

### 1. Technical Field

The present disclosure relates to an antenna device.

### 2. Related Art

An antenna for use, for example, in a radar for monitoring the area around a mobile communication device and a mobile body is demanded to be reduced in size. As one of antennas of this type, a planar antenna is known, which includes a printed board having a first surface on which an antenna element is provided and a second surface on which a conductor plate is provided. In this planar antenna, the operation frequency is determined by the size of its antenna element, and the antenna element is smaller as the operation frequency is higher. Briefly, the size of the antenna is mainly determined by the operation frequency.

### SUMMARY

The present disclosure provides an antenna device. An antenna device according to one mode of the present disclosure includes a dielectric substrate, an antenna part and a base plate. The antenna device includes the dielectric substrate having a first surface on which the antenna part is formed and a second surface on which the base plate is formed. The antenna part has one or more antenna patterns configured to act as radiating elements. The antenna patterns resonate in one or more resonance directions to incident waves having an operating frequency of the antenna part, thereby generating emitted waves having polarized waves different from those of transmitted/received waves which are transmitted/received by the antenna part. For each of the resonance directions, the antenna patterns include at least one line pattern having a width which is narrower than the total width of the antenna patterns in a direction perpendicular to the resonance direction.

### BRIEF DESCRIPTION OF THE DRAWINGS

In the accompanying drawings:

FIG. 1 is a perspective view showing the configuration of an antenna device;

FIG. 2 is an explanatory view regarding a capacitance component and an inductance component to determine an operation frequency;

FIG. 3 is an explanatory view showing the influence of manufacturing variations on an antenna pattern;

FIG. 4 is a graph showing the influence of the manufacturing variations on the operation frequency in the antenna device according to the present disclosure;

FIG. 5 is a graph showing the influence of the manufacturing variations on the operation frequency in a conventional antenna device;

FIG. 6 is a graph showing the influence of the manufacturing variations on directivity in the antenna device according to the present disclosure;

FIG. 7 is a graph showing the influence of the manufacturing variations on the directivity in the conventional antenna device;

FIG. 8 is an explanatory view showing a variant of the antenna pattern;

FIG. 9 is an explanatory view showing a variant of the antenna pattern;

FIG. 10 is an explanatory view showing a variant of the antenna pattern;

FIG. 11 is an explanatory view showing a variant of the antenna pattern;

FIG. 12 is an explanatory view showing a variant of the antenna pattern;

FIG. 13 is an explanatory view showing a variant of the antenna pattern;

FIG. 14 is an explanatory view showing a variant of the antenna pattern; and

FIG. 15 is an explanatory view showing a variant of the antenna pattern.

### DETAILED DESCRIPTION OF THE PREFERRED EMBODIMENTS

The inventors of the present disclosure have studied the following technique for realizing both reduction in size of an antenna device and suppression of the deterioration in performance caused by manufacturing variations.

For example, JP 2014-103591 A (hereinafter referred to as “PTL 1”) discloses a technique of providing a stub line between an antenna element and a conductor plate in a planar antenna, and reducing the size of the antenna element by utilizing the characteristic that the resonance frequency is shifted to a low frequency side by due to the additional capacitance of this stub line.

However, the related art described in PTL 1 has been found to involve the problem that, because of a necessity to provide the stub line within the substrate, labor is required for manufacture.

There has also been found the problem that, if the pattern size of the antenna element is different from the desired size due to manufacturing variations, the resonance frequency would be shifted.

One aspect of the present disclosure resides in providing a technique for realizing both reduction in size of an antenna device and suppression of the deterioration in performance caused by manufacturing variations.

An antenna device according to one mode of the present disclosure includes a dielectric substrate, an antenna part and a base plate.

The antenna part is formed on a first surface of the dielectric substrate and has one or more antenna patterns configured to act as radiating elements. The base plate is formed on a second surface of the dielectric substrate and acts as an antenna ground contact surface. The antenna patterns resonate in one or more resonance directions to incident waves having an operating frequency of the antenna part, thereby generating emitted waves having polarized waves different from those of transmitted/received waves which are electromagnetic waves transmitted/received by the antenna part. For each of the resonance directions, the antenna patterns include at least one line pattern having a width which is narrower than the total width of the antenna patterns in a direction perpendicular to the resonance direction.

According to such a configuration, the capacitance of the antenna patterns reduces, and thus the resonance frequency of the antenna patterns can be reduced. As a result, it is possible to realize a further reduction in external size of the antenna patterns if the same resonance frequency is employed, and, therefore, a reduction in size of the antenna device.

The line of the line pattern becomes long and thin, and the inductance increases, in the case of overetching. The line of the line pattern becomes short and thick, and the inductance decreases, in the case of underetching. The total area of the antenna patterns, i.e., capacitance C decreases with overetching and increases with underetching. That is, in either case, their changes are offset each other. So, it is possible to suppress changes in characteristics caused by manufacturing variations.

Reference numbers in parentheses in the claims indicate correspondences with specific means according to an embodiment which will be described as a mode below, and do not limit the technical scope of the present disclosure.

An embodiment of the present disclosure will hereinafter be described with reference to the drawings.

### [1. Configuration]

An antenna device 1 is used, for example, in a millimeter wave radar for detecting various targets which are present on the area around a vehicle. However, the application of the antenna device 1 is not limited to this, and it may be applied, for example, to various instruments and systems required to transmit/receive electromagnetic waves.

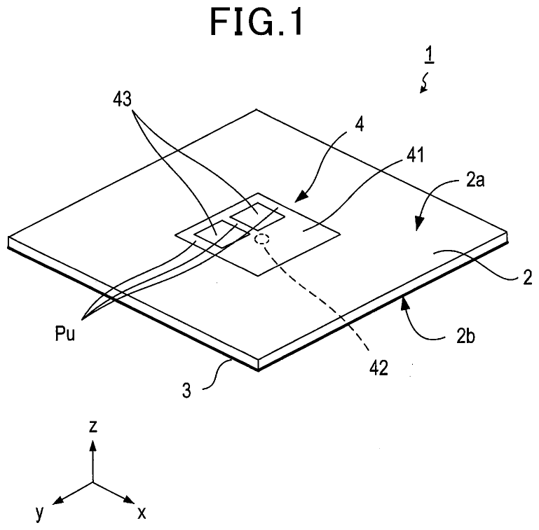

The antenna device 1 has a rectangular dielectric substrate 2 as shown in FIG. 1. Hereinafter, a first surface of the dielectric substrate 2 is referred to as substrate front surface 2a, and a second surface thereof is referred to as substrate rear surface 2b. Further, the direction along a first side of the dielectric substrate 2 is referred to as x-axis direction, the direction along a second side perpendicular to the x-axis direction is referred to as y-axis direction, and the normal direction of the substrate front surface 2a is referred to as z-axis direction.

The substrate rear surface 2b is provided with a base plate 3 that functions as a ground contact surface. The base plate 3 is a copper pattern covering the entire substrate rear surface 2b. The substrate front surface 2a is provided with an antenna part 4 near its center.

The antenna part 4 has one or more antenna patterns 41. The individual antenna patterns 41 are copper patterns having a rectangular outer shape. FIG. 1 shows the case where the antenna part 4 includes a single antenna pattern 41 for easily viewing this figure, but the antenna part 4 may include a plurality of the antenna patterns 41.

The antenna pattern 41 is provided with a feed point 42 which receives power supplied to transmit/receive electromagnetic waves whose polarized wave direction is along the x-axis direction. Specifically, in the antenna pattern 41, the feed point 42 is provided at a position located near the center position of the y-axis direction and shifted from the center position of the x-axis direction, i.e., at a position biased in the right front direction of FIG. 1 herein. Power supply to the feed point 42 is configured to be performed by a feed line provided on the side of the substrate rear surface 2b, though not shown.

The antenna pattern 41 has two pattern-removed regions 43 formed by removing a part of the antenna pattern 41.

Both of the two pattern-removed regions 43 have a rectangular shape and are arranged on an area having a wide width from the feed point 42 to an outer side forming the outer circumference of the antenna pattern 41 when looking in the x-axis direction from the feed point 42. Also, the two pattern-removed regions 43 are arranged in such a manner that the respective sides defining the boundary of the respective pattern-removed regions 43 are parallel with any of the outer sides of the antenna pattern 41 and that the pattern-removed regions 43 are aligned at a constant interval. Thus, a plurality of line patterns Pu along the resonance direction (i.e., x-axis direction) are formed between the two pattern-removed regions 43 and between each of the pattern-removed regions 43 and the outer side which is parallel to the x-axis of the antenna pattern 41. The line patterns Pu are all narrower than the width of the antenna pattern 41 in a direction (i.e., y-axis direction) perpendicular to the resonance direction. That is, a width of the line pattern Pu is narrower than the width of the antenna pattern 41. The line pattern Pu formed between the two pattern-removed regions 43 is positioned on a virtual line along the resonance direction passing through the feed point 42.

### [2. Operation]

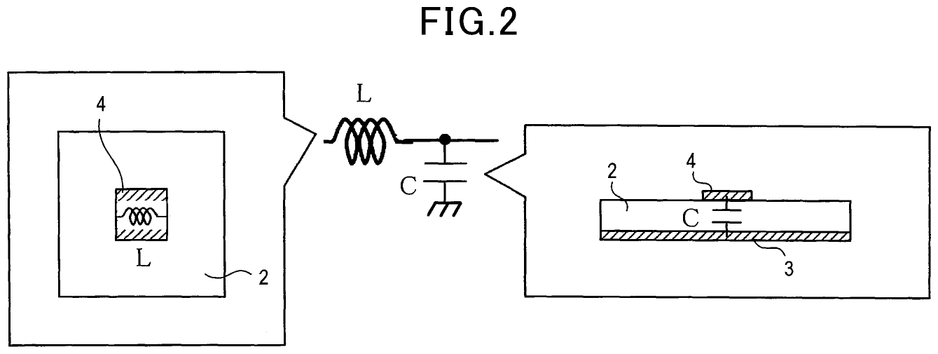

Now, the operation frequency of the antenna pattern 41 will be described. As shown in FIG. 2, the equivalent circuit of the antenna pattern 41 serves as a serial resonance circuit constituted by a capacitance component C and an inductance component L. Accordingly, the resonance frequency of the antenna pattern 41 is obtained by Formula (1):

$$\begin{matrix}[ Mathematical Formula 1 ] & \\ f = \frac{1}{2 π \sqrt{L \cdot C}} & ( 1 )\end{matrix}$$

The inductance component L is determined depending, for example, on the width and length of the antenna pattern 41 on the assumption that current flows to the antenna pattern 41 in the resonance direction. The capacitance component is formed between the antenna pattern 41 and the base plate 3 and determined depending, for example, on the area of the antenna pattern 41, the thickness of the dielectric substrate 2 and the dielectric constant of the dielectric substrate 2.

Since a line pattern Pu narrower than the width of the outer sides of the antenna pattern 41 is formed by the two pattern-removed regions 43 in the antenna pattern 41, the inductance component L increases. Therefore, if the same external size is employed, the resonance frequency of the antenna pattern 41 having the pattern-removed regions 43 according to the present disclosure reduces as compared with that of a conventional antenna pattern having no pattern-removed region 43. Namely, when an attempt is made to realize the same resonance frequency with the antenna pattern 41 according to the present disclosure and with the conventional antenna pattern, the external size of the antenna pattern 41 can be reduced more. For example, when configured to operate at 24 GHz, the conventional antenna pattern has sides of 3.1 mm, however the antenna pattern 41 according to the present disclosure can have sides of 2.88 mm.

Then, the influence of manufacturing variations on the antenna characteristics will be described.

In a conventional antenna pattern, when the external size of the antenna pattern is smaller than the desired size by overetching, both of L and C decrease. When the changes in L and C are represented as ΔL and ΔC, an operation frequency f is expressed by Formula (2):

$$\begin{matrix}[ Mathematical Formula 2 ] & \\ f = \frac{1}{2 π \sqrt{( L - Δ L ) \cdot ( C - Δ C )}} & ( 2 )\end{matrix}$$

In the case of underetching, the signs of symbols of ΔL and ΔC are inverted.

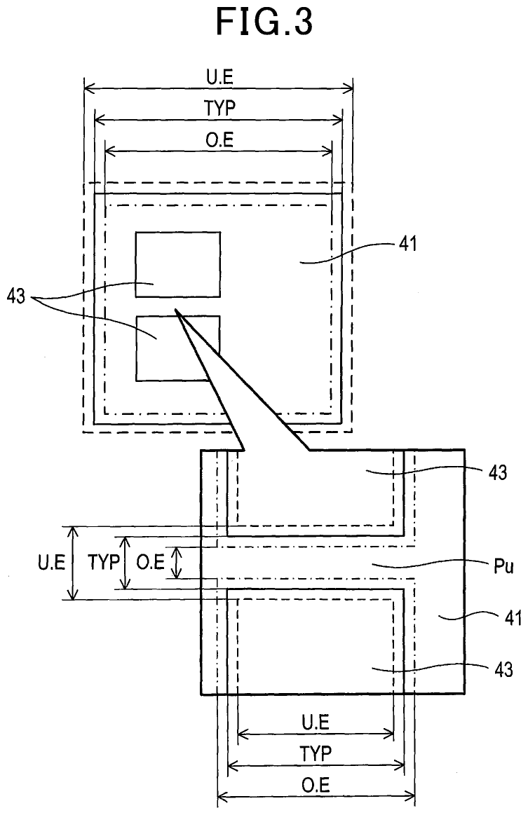

In the antenna pattern 41 according to the present disclosure, the external size of the antenna pattern 41 is made smaller than the desired size by overetching, as shown in FIG. 3, so that C and an inductance component L1 of a portion other than the line patterns Pu decrease as is the case with the conventional antenna pattern. However, the pattern-removed region 43 is widened by overetching, so that the length of the line patterns Pu increases and the width thereof decreases. So, an inductance component L2 of the line patterns Pu increases. When the changes in C, L1 and L2 are defined as ΔC, ΔL1 and ΔL2, the operation frequency f is expressed by Formula (3):

$$\begin{matrix}[ Mathematical Formula 3 ] & \\ f = \frac{1}{2 π \sqrt{( L 1 - Δ L 1 + L 2 + Δ L 2 ) \cdot ( C - Δ C )}} & ( 3 )\end{matrix}$$

In the case of underetching, the signs of symbols of ΔL1, ΔL2 and ΔC are inverted. In FIG. 3, the size as designed is referred to as TYP; the overetched size is referred to as O.E; and the underetched size is referred to as U.E.

Namely, in either case of overetching and underetching, ΔL2 changes in a direction opposite to ΔL1 and ΔC, and thus acts in a direction suppressing change in the operation frequency f. It is desirable that the size of the pattern-removed regions 43 and, therefore, the size of the line patterns Pu be set to satisfy ΔL1<ΔL2 in consideration of a pattern tolerance at the time of manufacture, and further set so that (ΔL1−ΔL2)/(L1+L2) and ΔC/C are equivalent to each other.

### [3. Effect]

The embodiment described in detail above provides the following effects.

(1) In the antenna device 1, the antenna pattern 41 includes the plurality of line patterns Pu formed by the plurality of pattern-removed regions 43. So, it is possible to suppress changes in resonance frequency due to the variations in pattern caused during etching, i.e., the manufacturing variations.

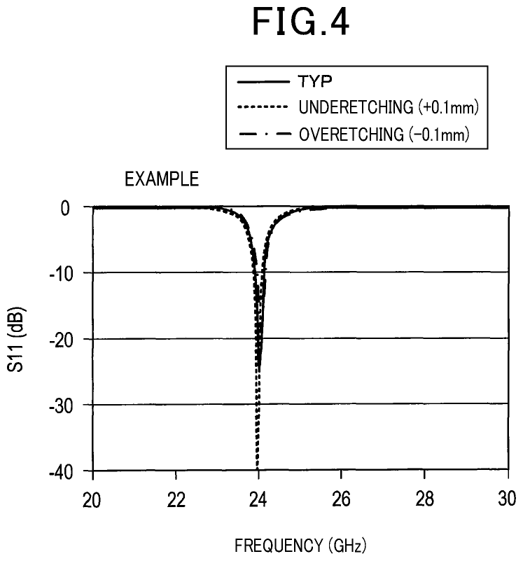

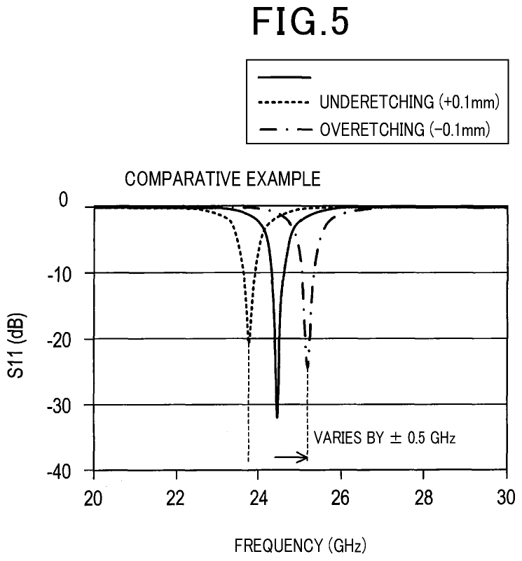

FIGS. 4 and 5 show results of determination, through simulation, of the frequency characteristics of S parameter S11 of the antenna device 1 by appropriately changing the pattern tolerance which indicates manufacturing variations. Here, the antenna device 1 was designed to operate in the vicinity of 24 GHz, and simulation was performed on TYP when the pattern width was a value as designed (i.e., pattern tolerance: 0 mm), underetching when the pattern width was wider than the designed value (for example, pattern tolerance +0.1 mm) and overetching when the pattern width was narrower than the designed value (for example, pattern tolerance −0.1 mm). FIG. 4 shows the case of an Example of the antenna device 1 according to the present disclosure, and FIG. 5 shows the case of a Comparative Example. In the Comparative Example, a simple square antenna pattern having no pattern-removed region 43 is used in place of the antenna pattern 41 having the pattern-removed regions 43.

As can be seen from FIGS. 4 and 5, S11 is maximum in the vicinity of 24 GHz and the resonance frequency is almost unchanged, regardless of the manufacturing variations, in the Example. However, in the Comparative Example, the frequency at which S11 is minimum is shifted by ±0.5 GHz from 24 GHz, i.e., the resonance frequency greatly changes due to the manufacturing variations.

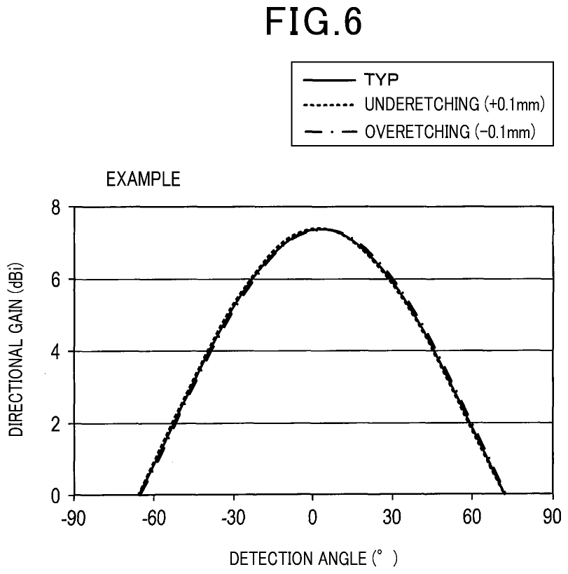

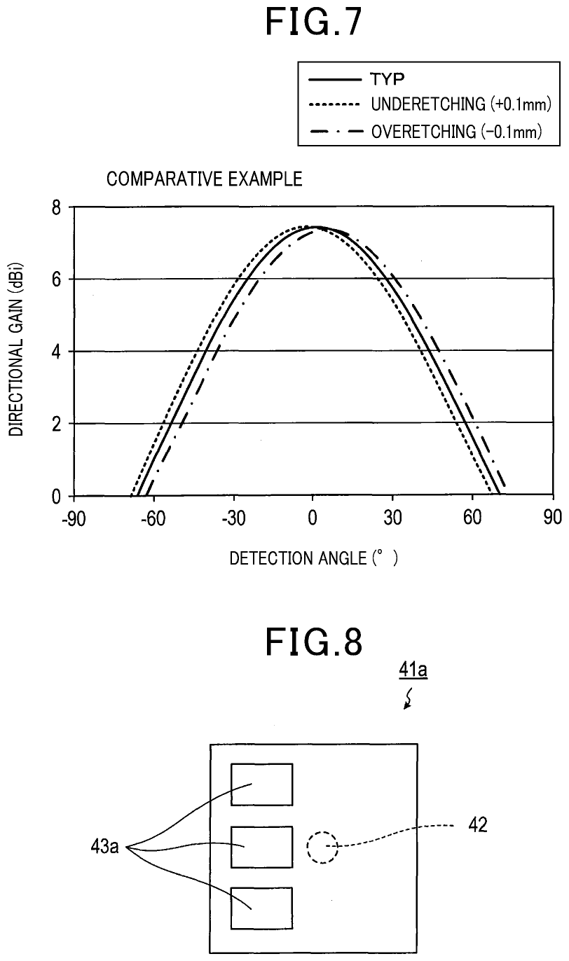

(2) FIGS. 6 and 7 show results of calculation, through simulation, of a gain of signals at 24 GHz within a detection angle range of ±90° with respect to the front direction of the antenna (i.e., z-axis direction). Here, simulation was performed on the cases of TYP, underetching and overetching, similarly as for the frequency characteristics of S11 described above. FIG. 6 shows the case of the Example, and FIG. 7 shows the case of the Comparative Example.

As can be seen from FIGS. 6 and 7, the directivity is almost unchanged, regardless of the manufacturing variations, in the Example. However, in the Comparative Example, not only the resonance frequency changes, but also the directivity is shifted by about ±several degrees, due to the manufacturing variations. Hence, in the antenna device 1, stable antenna characteristics are obtained, regardless of the variations at the time of manufacture.

### [4. Other Embodiments]

The embodiment of the present disclosure has been described above. However, the present disclosure is not limited to the above-described embodiment, and may be carried out in various modified forms.

(a) The antenna pattern 41 is provided with two pattern-removed regions 43 formed so as to have the same size in the above-described embodiment. However, the present disclosure is not limited to this. For example, the number of pattern-removed regions 43a may be 3, not less than 3, or 1, as in an antenna pattern 41a shown in FIG. 8.

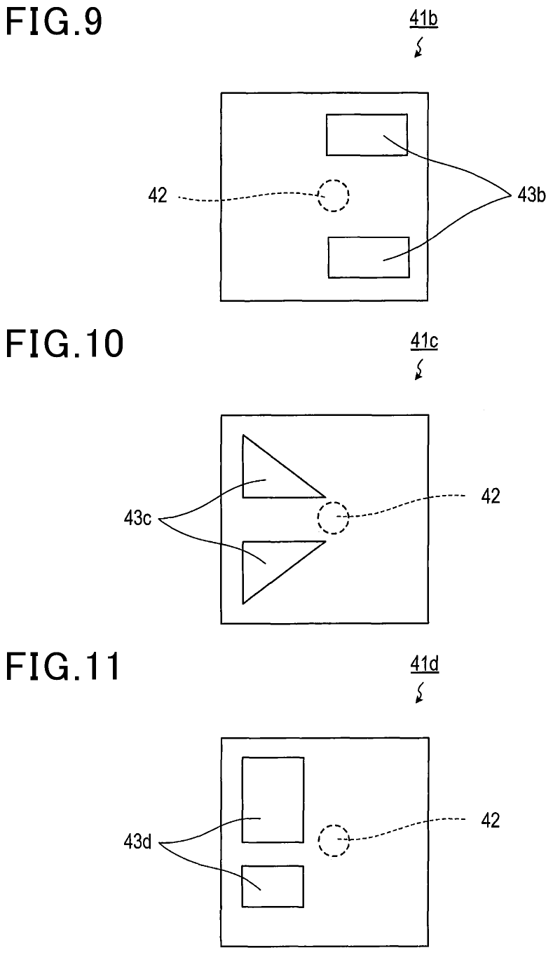

(b) In the above-described embodiment, in the antenna pattern 41, the pattern-removed regions 43 are provided on an area having a wide width from the feed point 42 to the outer circumference of the antenna pattern 41 when looking in the x-axis direction from the feed point 42. However, the present disclosure is not limited to this. For example, as in an antenna pattern 41b shown in FIG. 9, pattern-removed regions 43b may be provided on an area having a narrow width from the feed point 42 to the outer circumference of the antenna pattern 41b when looking in the x-axis direction from the feed point 42.

(c) In the above-described embodiment, the shape of the pattern-removed regions 43 in the antenna pattern 41 is rectangular. However, the present disclosure is not limited to this. For example, the shape of pattern-removed regions 43c may be right-triangular, as in an antenna pattern 41c shown in FIG. 10. In addition to this, the shape of the pattern-removed regions may be pentagonal or more polygonal, circular or elliptical, or a combination of these shapes. When the pattern-removed regions each have a shape having a specific side which is a linear side, the pattern-removed regions are desirably arranged in such a manner that the specific side defines the boundary of the line pattern Pu.

(d) In the above-described embodiment, the plurality of pattern-removed regions 43 in the antenna pattern 41 are formed so as to have the same shape and size. However, the present disclosure is not limited to this. For example, a plurality of pattern-removed regions 43d may be different in size, as in an antenna pattern 41d shown in FIG. 11. Alternatively, the plurality of pattern-removed regions may be mutually different not only in size, but also in shape.

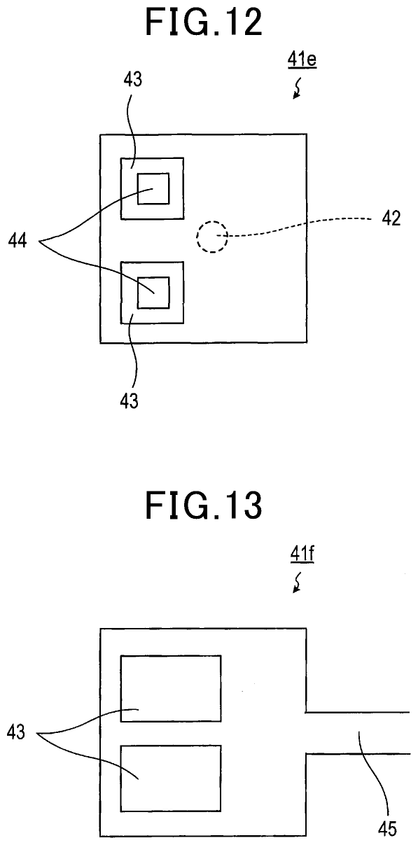

(e) In the above-described embodiment, the pattern has been simply removed in the pattern-removed regions 43 of the antenna pattern 41. However, the present disclosure is not limited to this. For example, an internal pattern 44 which is electrically isolated from an antenna pattern 41e may be formed within each pattern-removed region 43, as in an antenna pattern 41e shown in FIG. 12. In this case, the internal pattern 44 may have a shape similar to that of the pattern-removed region 43 or any other shape.

(f) In the above-described embodiment, the antenna pattern 41 is configured to receive supplied power from the substrate rear surface 2b to the feed point 42. However, the present disclosure is not limited to this. For example, the antenna pattern may be configured to receive supplied power via a feed line pattern 45 provided on the substrate front surface 2a, as in an antenna pattern 41f shown in FIG. 13.

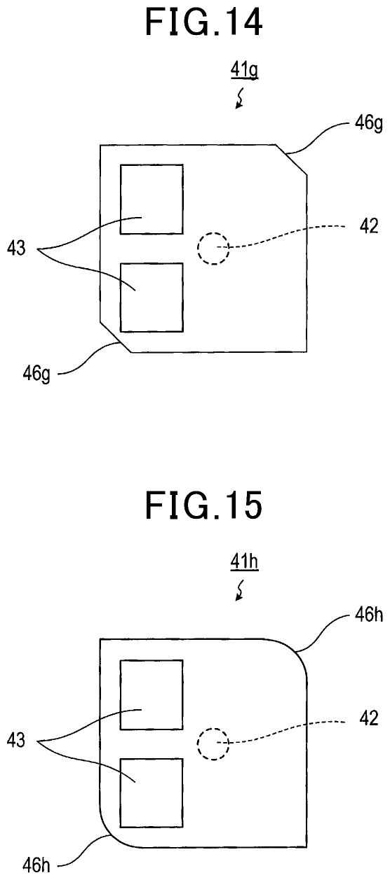

(g) In the above-described embodiment, the antenna pattern 41 is configured to transmit/receive electromagnetic waves which are linearly polarized waves. However, the present disclosure is not limited to this. For example, as in an antenna pattern 41g shown in FIG. 14 or an antenna pattern 41h shown in FIG. 15, the antenna pattern may be configured to transmit/receive circularly or elliptically polarized waves by forming notch parts 46g or 46h at a pair of apex portions positioned on a diagonal line of the antenna pattern 41g or 41h. The notch parts 46g shown in FIG. 14 each have a shape in which an area near the apex is cut out linearly, and the notch parts 46h shown in FIG. 15 each have a shape in which an area near the apex is cut out arcuately.

(h) A plurality of functions of one constituent element in the above embodiment may be realized by a plurality of constituent elements, or one function of one constituent element may be realized by a plurality of constituent elements. In addition, a plurality of functions of a plurality of constituent element may be realized by one constituent element, or one function realized by a plurality of constituent elements may be realized by one constituent element. Moreover, a part of the components of the above-described embodiment may be omitted. Furthermore, at least a part of the components of the above-described embodiment may be added to or replaced with the components of another embodiment described above. Incidentally, all aspects included in the technical idea specified from the language described in the claims are embodiments of the present disclosure.

(i) In addition to the antenna device described above, the present disclosure can also be realized in various forms, such as a system including the antenna device as a component.

What is claimed is:

1. An antenna device comprising:
a dielectric substrate;
an antenna part formed on a first surface of the dielectric substrate and having one or more antenna patterns configured to act as radiating elements; and
a base plate formed on a second surface of the dielectric substrate and configured to act as an antenna ground contact surface,
wherein the antenna patterns are each formed in a shape provided with at least one line pattern having a width which is narrower than the total width of the antenna patterns in a direction perpendicular to a resonance direction of resonating electromagnetic waves on the antenna patterns.

2. The antenna device according to claim 1, wherein the line pattern is provided at least on a virtual line along the resonance direction passing through a feed point of the respective antenna patterns.

3. The antenna device according to claim 1, wherein:
a feed point of the respective antenna patterns is arranged at a position biased to one side of the resonance direction with respect to the center on a diagonal line of the antenna pattern, and;
the line pattern is provided on an area having a wider width from the feed point to the outer circumference of the antenna pattern when looking in the resonance direction from the feed point.

4. The antenna device according to claim 1, wherein:
a feed point of the respective antenna patterns is formed at a position biased to one side of the resonance direction with respect to the center on a diagonal line of the antenna pattern, and;
the line pattern is provided on an area having a narrower width from the feed point to the outer circumference of the antenna pattern when looking in the resonance direction from the feed point.

5. The antenna device according to claim 1, wherein the line pattern is provided by forming, in the respective antenna patterns, one or more pattern-removed regions in which the pattern has been removed in a preset shape.

6. The antenna device according to claim 5, wherein the line pattern is provided at least between the respective pattern-removed regions and the outer periphery of the respective antenna patterns.

7. The antenna device according to claim 5, wherein the line pattern is provided at least between the pattern-removed regions.

8. The antenna device according to claim 5, wherein the pattern-removed regions are each formed in a polygonal shape having at least a specific side which is a side along the resonance direction, and arranged in such a manner that the specific side forms the boundary of the line pattern.

9. The antenna device according to claim 5, further comprising an internal pattern formed in the respective pattern-removed regions, the internal pattern being electrically isolated from the antenna patterns.

10. The antenna device according to claim 9, wherein the internal pattern has a shape similar to the outer shape of the pattern-removed regions.
